(19) United States
(12) Patent Application Publication
(10) Pub. No.: US 2024/0114477 A1
(43) Pub. Date: Apr. 4, 2024

(54) POSITIONING MODEL PERFORMANCE MONITORING

(71) Applicant: QUALCOMM Incorporated, San Diego, CA (US)

(72) Inventors: Srinivas YERRAMALLI, San Diego, CA (US); Mohammed Ali Mohammed HIRZALLAH, San Diego, CA (US); Taesang YOO, San Diego, CA (US); Jay Kumar SUNDARARAJAN, San Diego, CA (US)

(21) Appl. No.: 18/466,088

(22) Filed: Sep. 13, 2023

Related U.S. Application Data
(60) Provisional application No. 63/377,974, filed on Sep. 30, 2022.

(51) Int. Cl. H04W 64/00; G06N 20/00

(52) U.S. Cl. CPC H04W 64/00; G06N 20/00

(57) ABSTRACT

Various aspects of the present disclosure generally relate to wireless communication. In some aspects, an apparatus may obtain a set of training measurement information associated with a user equipment (UE). The apparatus may obtain a training position value associated with the UE. The apparatus may provide the training position value and the set of training measurement information for training of a model using a machine learning (ML) technique, the model being trained to output location information based at least in part on measurement information. Numerous other aspects are described.

### CROSS-REFERENCE TO RELATED APPLICATION

This Patent application claims priority to U.S. Provisional Patent Application No. 63/377,974, filed on Sep. 30, 2022, entitled “POSITIONING MODEL PERFORMANCE MONITORING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for positioning model performance monitoring.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus. The method may include obtaining a set of training measurement information associated with a user equipment (UE). The method may include obtaining a training position value associated with the UE. The method may include providing the training position value and the set of training measurement information for training of a model using a machine learning (ML) technique, the model being trained to output location information based at least in part on measurement information.

Some aspects described herein relate to a method of wireless communication performed by a network node. The method may include obtaining training measurement information for a UE, or information associated with the training measurement information, the training measurement information being associated with training a model using an ML technique. The method may include outputting, for the UE, a training position value based at least in part on the training measurement information or the information associated with the training measurement information.

Some aspects described herein relate to an apparatus for wireless communication. The apparatus may include a memory and one or more processors coupled to the memory. The one or more processors may be configured to obtain a set of training measurement information associated with a UE. The one or more processors may be configured to obtain a training position value associated with the UE. The one or more processors may be configured to provide the training position value and the set of training measurement information for training of a model using a machine learning (ML) technique, the model being trained to output location information based at least in part on measurement information.

Some aspects described herein relate to a network node for wireless communication. The network node may include a memory and one or more processors coupled to the memory. The one or more processors may be configured to obtain training measurement information for a UE, or information associated with the training measurement information, the training measurement information being associated with training a model using an ML technique. The one or more processors may be configured to output, for the UE, a training position value based at least in part on the training measurement information or the information associated with the training measurement information.

Some aspects described herein relate to a non-transitory computer-readable medium that stores a set of instructions for wireless communication. The set of instructions, when executed by one or more processors of an apparatus, may cause the one or more processors to obtain a set of training measurement information associated with a UE. The set of instructions, when executed by one or more processors, may cause the apparatus to obtain a training position value associated with the UE. The set of instructions, when executed by one or more processors, may cause the apparatus to provide the training position value and the set of training measurement information for training of a model using a machine learning (ML) technique, the model being trained to output location information based at least in part on measurement information.

Some aspects described herein relate to a non-transitory computer-readable medium that stores a set of instructions for wireless communication by a network node. The set of instructions, when executed by one or more processors of the network node, may cause the network node to obtain training measurement information for a UE, or information associated with the training measurement information, the training measurement information being associated with training a model using an ML technique. The set of instructions, when executed by one or more processors of the network node, may cause the network node to output, for the UE, a training position value based at least in part on the training measurement information or the information associated with the training measurement information.

Some aspects described herein relate to an apparatus for wireless communication. The apparatus may include means for obtaining a set of training measurement information associated with a UE. The apparatus may include means for obtaining a training position value associated with the UE. The apparatus may include means for providing the training position value and the set of training measurement information for training of a model using a machine learning (ML) technique, the model being trained to output location information based at least in part on measurement information.

Some aspects described herein relate to an apparatus for wireless communication. The apparatus may include means for obtaining training measurement information for a UE, or information associated with the training measurement information, the training measurement information being associated with training a model using an ML technique. The apparatus may include means for outputting, for the UE, a training position value based at least in part on the training measurement information or the information associated with the training measurement information.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example architecture of a functional framework for RAN intelligence enabled by data collection, in accordance with the present disclosure.

FIG. 5 is a diagram illustrating an example of artificial intelligence and/or machine learning (AI/ML) based position determination, in accordance with the present disclosure.

FIG. 6 is a diagram illustrating an example of signaling associated with obtaining a training position value for training of a model, in accordance with the present disclosure.

FIG. 7 is a diagram illustrating an example process performed, for example, by an apparatus, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

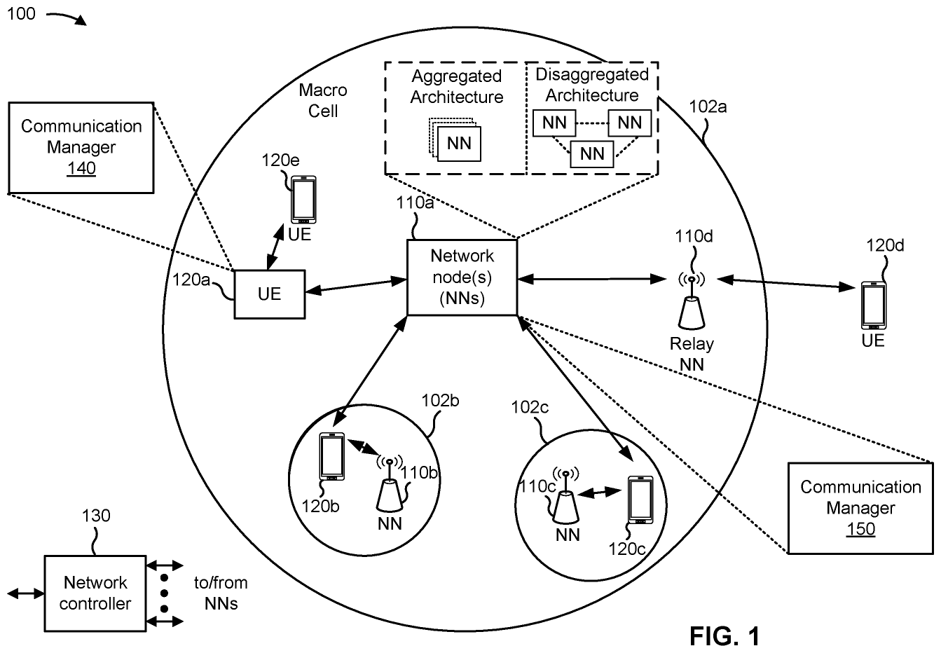

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE may include a communication manager 140. As described in more detail elsewhere herein, the communication manager 140 may obtain a set of training measurement information associated with a UE; obtain a training position value associated with the UE; and provide the training position value and the set of training measurement information for training of a model using a machine learning (ML) technique, the model being trained to output location information based at least in part on measurement information. Additionally, or alternatively, the communication manager 140 may perform one or more other operations described herein.

In some aspects, the network node 110 may include a communication manager 150. As described in more detail elsewhere herein, the communication manager 150 may obtain training measurement information for a UE, or information associated with the training measurement information, the training measurement information being associated with training a model using an ML technique; and output, for the UE, a training position value based at least in part on the training measurement information or the information associated with the training measurement information. Additionally, or alternatively, the communication manager 150 may perform one or more other operations described herein.

As indicated above, FIG. 1 is provided as an example. Other examples may differ from what is described with regard to FIG. 1.

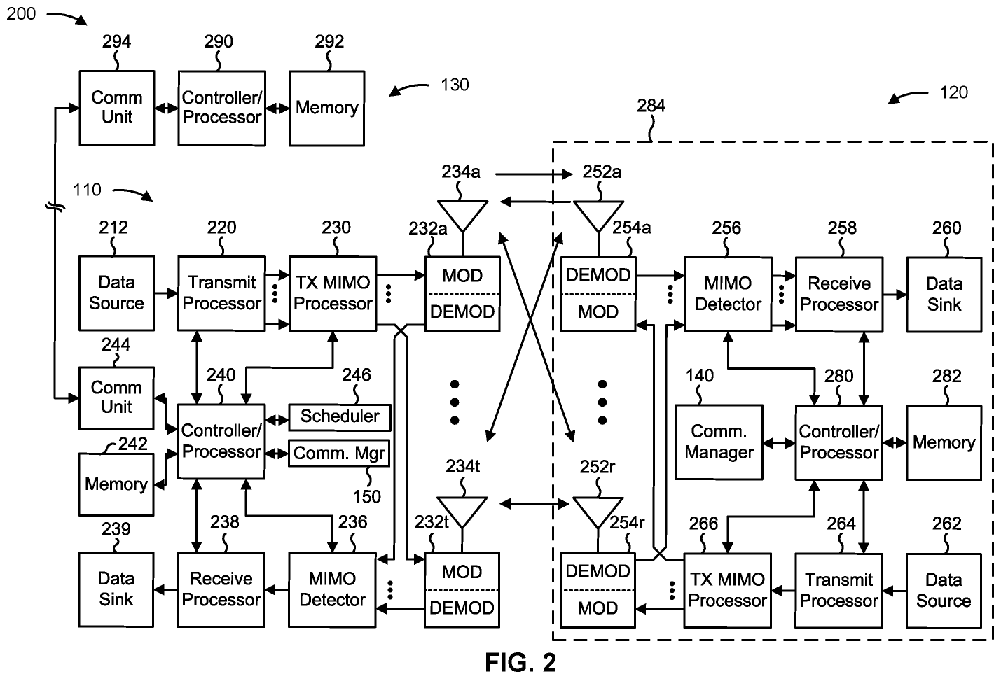

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may obtain a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may obtain a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

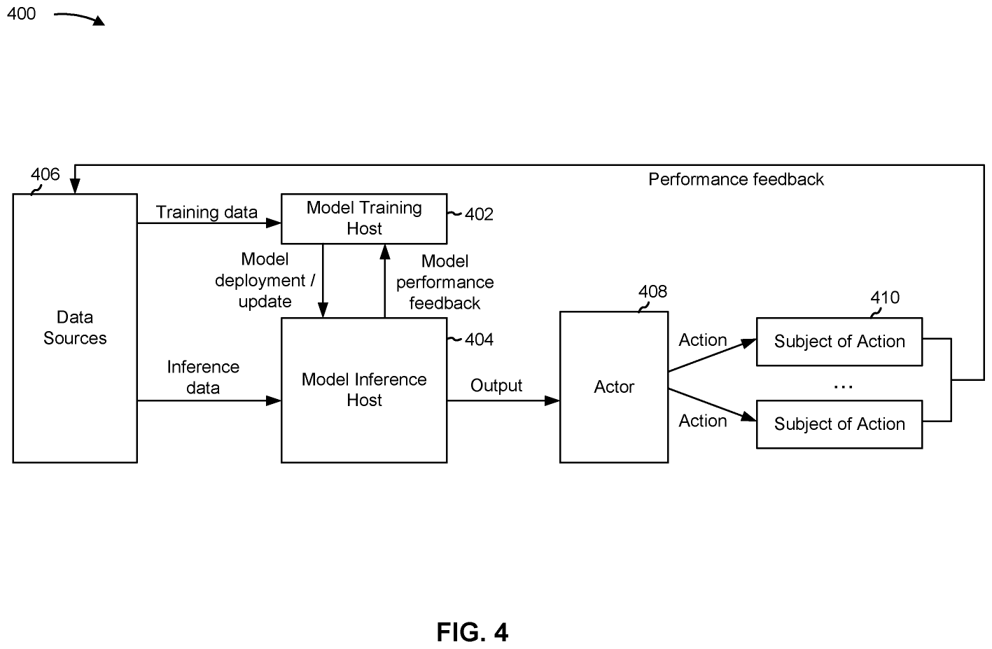

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

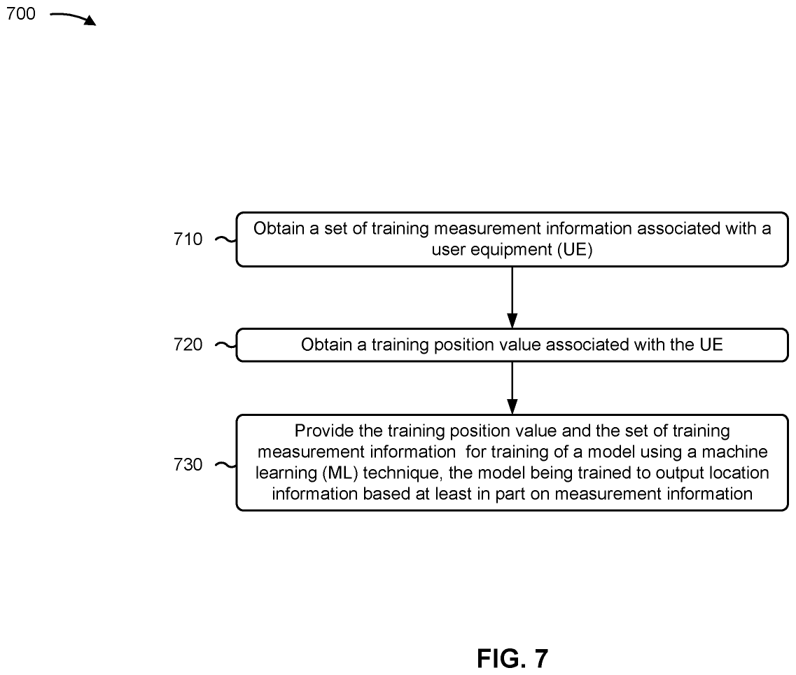

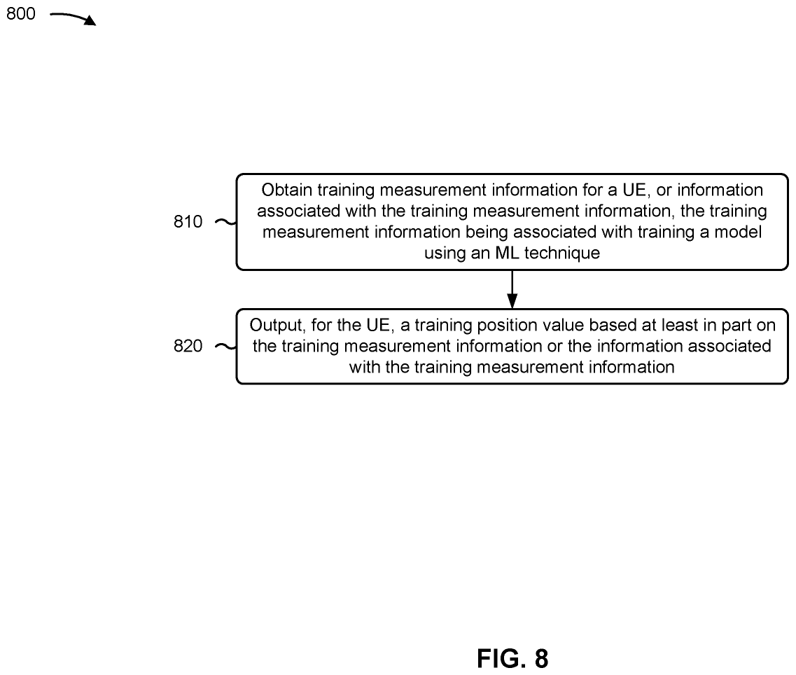

The controller/processor 240 of the network node 110, the controller/processor 280 of the UE 120, and/or any other component(s) of FIG. 2 may perform one or more techniques associated with positioning model performance monitoring, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, an apparatus (e.g., a UE) includes means for obtaining a set of training measurement information associated with a UE; means for obtaining a training position value associated with the UE; and/or means for providing the training position value and the set of training measurement information for training of a model using an ML technique, the model being trained to output location information based at least in part on measurement information. In some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining training measurement information for a UE, or information associated with the training measurement information, the training measurement information being associated with training a model using an ML technique; and/or means for outputting, for the UE, a training position value based at least in part on the training measurement information or the information associated with the training measurement information. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

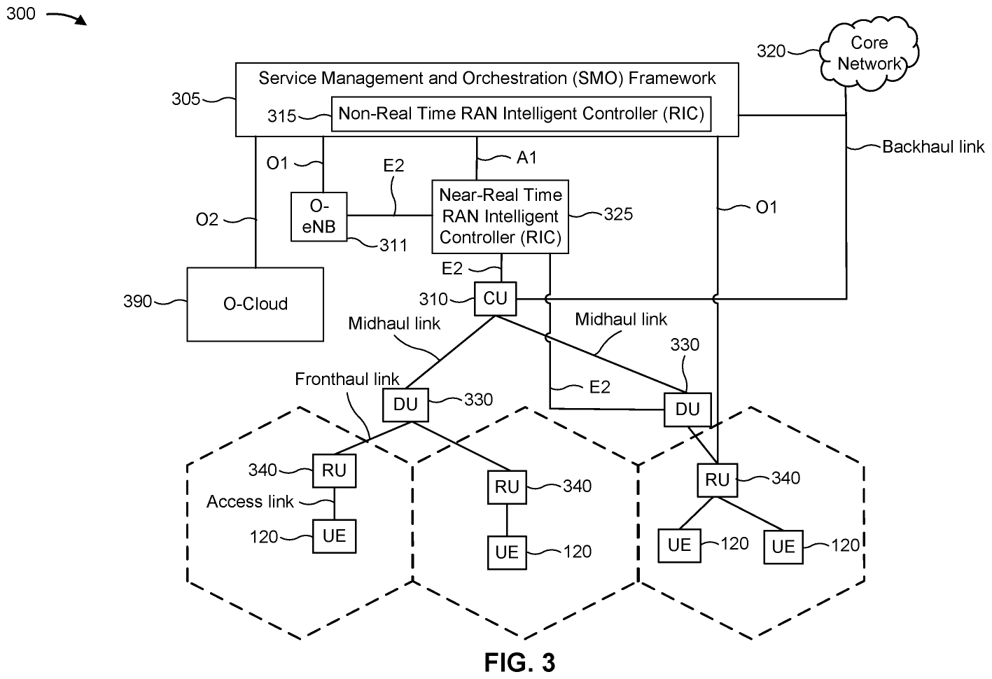

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example architecture 400 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (e.g., a prediction) with the inference data input to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with position determination, the actor 408 may be a UE, a DU or an RU. In some examples, the model inference host 404 may be hosted on the actor 408. For example, a UE may be the actor 408 and may host the model inference host 404. In some aspects, a UE (e.g., the actor 408) may be a data source 406. For example, the UE may perform a measurement (e.g., an NR measurement), may input the measurement to the AI/ML model at the model inference host 404 (or may provide the measurement to the model inference host 404), and may act based on an output of the AI/ML model (e.g., positioning information).

After the actor 408 receives an output from the model inference host 404, the actor 408 may determine whether to act based on the output. For example, if the actor 408 is a UE and the output from the model inference host 404 is associated with position information, the actor 408 may determine whether to report the position information, reconfigure a beam, or the like. If the actor 408 determines to act based on the output, in some examples, the actor 408 may indicate the action to at least one subject of action 410.

The data sources 406 may also be configured for collecting data that is used as training data for training an ML model or as inference data for feeding an ML model inference operation. For example, the data sources 406 may collect data from one or more core network and/or RAN entities, which may include the actor 408 or the subject of action 410, and provide the collected data to the model training host 402 for ML model training. In some aspects, the model training host 402 may be co-located with the model inference host 404 and/or the actor 408. For example, the actor 408 or the subject of action 410 may provide performance feedback associated with the beam configuration to the data sources 406, where the performance feedback may be used by the model training host 402 for monitoring or evaluating the ML model performance, such as whether the output (e.g., prediction) provided to the actor 408 is accurate. In some examples, the model training host 402 may monitor or evaluate ML model performance using a training position value, which may be provided by a node (e.g., a UE 120 or a network node 110), as described elsewhere herein. In some examples, if the output provided by the actor 408 is inaccurate (or the accuracy is below an accuracy threshold), then the model training host 402 may determine to modify or retrain the ML model used by the model inference host, such as via an ML model deployment/update.

Monitoring or evaluating AI/ML model performance may be valuable for lifecycle management (LCM). In this context, LCM may include management of AI/ML functionality of a wireless network. For example, LCM may include activation of AI/ML models, deactivation of AI/ML models, switching from one AI/ML model to another AI/ML model (such as in response to conditions relating to performance, suitability, or resource usage associated with the AI/ML models), training of AI/ML models, and so on.

As indicated above, FIG. 4 is provided as an example. Other examples may differ from what is described with regard to FIG. 4.

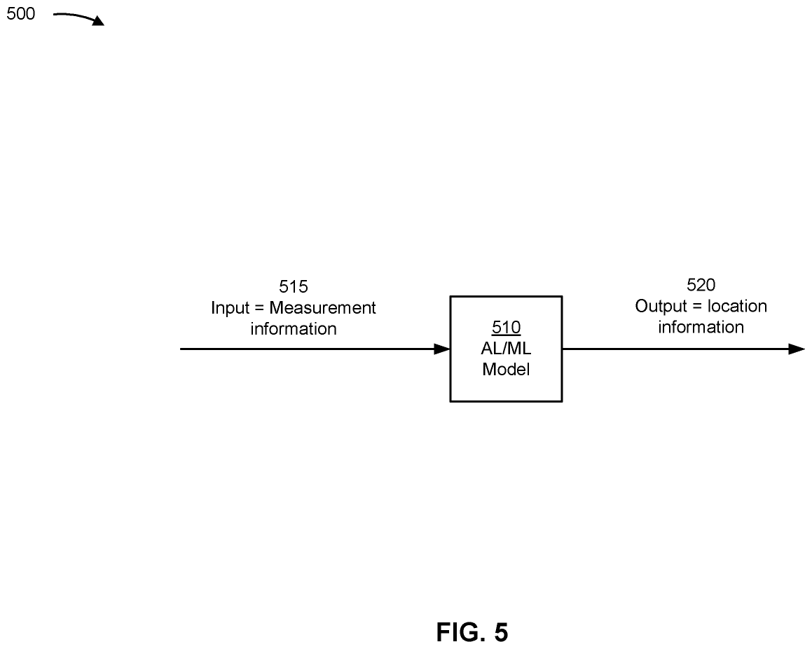

FIG. 5 is a diagram illustrating an example 500 of AI/ML based position determination, in accordance with the present disclosure. As shown in FIG. 5, an AI/ML model 510 may be deployed at or on a UE 120. For example, a model inference host (such as a model inference host 404) may be deployed at, or on, a UE 120. The AI/ML model 510 may enable the UE 120 to determine one or more inferences or predictions based on data input to the AI/ML model 510. In some examples, the AI/ML model 510 may be deployed at an AI/ML server associated with the UE 120 (not shown). For example, the AI/ML server may run the AI/ML model 510 and/or may train the AI/ML model 510.

For example, as shown by reference number 515, an input to the AI/ML model 510 may include measurement information. For example, the UE 120 may perform measurements (e.g., channel frequency response (CFR) measurements, channel input response (CIR) measurements, RSRP measurements, RSRQ measurements, signal-to-interference-plus-noise ratio (SINR) measurements, or the like) to obtain measurement information. The UE 120 may provide the measurement information as an input into the AI/ML model 510 (e.g., at the UE 120, or at an AI/ML server). In some aspects, the UE 120 may provide an intermediate value for the AI/ML model 510, such as a line-of-sight (LOS) information (e.g., a binary indication of an LOS state, an LOS probability, an indication of a non-LOS (NLOS) state, an NLOS probability, or a combination thereof), a reference signal time difference (RSTD), an angle of departure (AoD), an angle of arrival (AoA), a receive-transmit turnaround time, a channel multipath value (e.g., a channel path delay, a channel path phase, a channel path gain, or a combination thereof), or the like. An intermediate value may include information derived from measurement information.

As shown by reference number 520, the AI/ML model 510 may output one or more predictions. The one or more predictions may include location information regarding the UE 120. This may enable the UE 120 to determine a predicted (e.g., estimated, inferred) location of the UE 120, thereby conserving power of the UE 120 and/or resources that would have otherwise been used to determine a location of the UE 120 using more resource-intensive methods such as light detection and ranging (Lidar), global navigation satellite system (GNSS) data, inertial sensing, or the like.

The AI/ML model 510 may be trained using a set of training measurement information. The set of training measurement information may include, for example, measurement information obtained by the UE 120 and corresponding location information. The AI/ML model 510 may be trained to output location information based on inputted measurement information. For example, the AI/ML model 510 may output information indicating a position of the UE (referred to as a direct AI/ML method), and/or may output information indicating an intermediate value associated with a position, such as an LOS value, an RSTD, an AoD, an AoA, an Rx-Tx turnaround, a channel multipath value, an uplink measurement value, or the like (referred to as an AI/ML assisted method). An entity that trains the AI/ML model (e.g., the UE 120, a network node 110, or an AI/ML server) may monitor performance of the AI/ML model by comparing an output of the AI/ML model to a ground truth (sometimes referred to as a ground truth label). A ground truth or ground truth label, as used herein, may include information that is known to be, or treated as, true for the purposes of training or monitoring a model. For example, a ground truth indicating a position of a UE may be treated as an actual, observed position of the UE for the purpose of determining whether an inferred position of the UE (using the model) is accurate and/or for the purpose of training the model.

If performance of the model is unsatisfactory (e.g., if an output of the model deviates from a corresponding ground truth label by at least a threshold amount), the entity may train the AI/ML model (such as by using the corresponding ground truth label and measurement information used to generate the output of the model). However, some UEs may not be capable of generating ground truth labels with sufficient accuracy to enable useful performance monitoring of an AI/ML model. Furthermore, different sources of ground truth labels may provide ground truth labels of varying accuracy and quality. Still further, a derivative parameter (that is, a parameter such as a non-positioning-based performance metric derived from an operation of the UE, such as a throughput value or a beam failure parameter) may not be useful for performance monitoring of a positioning AI/ML model. For example, values of derivative parameters may vary for reasons other than positioning of the UE 120, meaning that these parameters may provide limited information regarding performance of the positioning AI/ML model. The unavailability of ground truth labels at the UE 120, as well as the inapplicability of derivative parameters for ground truth labeling, may lead to inaccurate model outputs, thereby degrading accuracy of UE positioning and reducing accuracy of the AI/ML model.

Some techniques described herein provide signaling of a training position value in association with training or monitoring of a model such as an AI/ML model. For example, a UE may obtain or receive, from a node (e.g., another UE or a network node 110), a training position value associated with the UE. The UE may provide the training position value, and (optionally) a set of training measurement information (which may include measurement information as described above) for training or monitoring of the model. As used herein, “training” can include training an AI/ML model (e.g., using an ML technique) and/or monitoring performance of the AI/ML model (which may trigger further training of the AI/ML model). In this way, accuracy of UE positioning and outputs of the AI/ML model are improved, by enabling the UE 120 or an AI/ML server associated with the UE 120 to acquire appropriate ground truth labels from another node.

As indicated above, FIG. 5 is provided as an example. Other examples may differ from what is described with regard to FIG. 5.

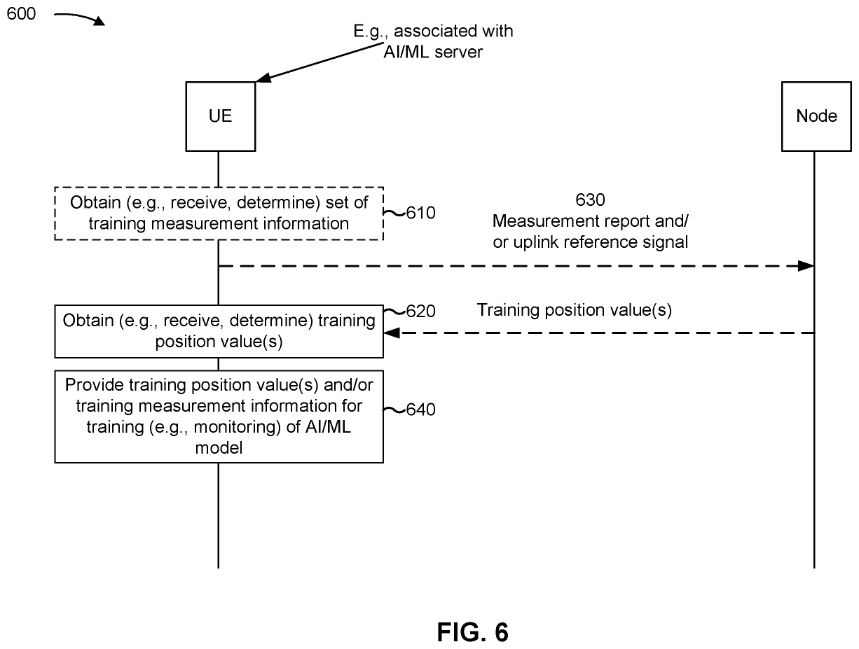

FIG. 6 is a diagram illustrating an example 600 of signaling associated with obtaining a training position value for training of a model (e.g., an AI/ML model), in accordance with the present disclosure. As shown, example 600 includes a UE (e.g., UE 120) and a node. The node may include, for example, another UE (e.g., UE 120), a network node (e.g., network node 110), or the like. As further shown, in some aspects, the UE may be associated with a server, such as an AI/ML server. In some aspects, the server may train the model. In some aspects, the server may run the model. For example, the server may receive measurement information from at least the UE, may input the measurement information to the model, and may provide, to at least the UE, location information (e.g., a position value or an intermediate value) output by the model.

As shown by reference number 610, in some aspects, the UE may optionally obtain a set of training measurement information. The set of training measurement information may include measurement information, such as a CIR value, a CFR value, an RSRP, a reference signal received path power (RSRPP), an RSTD, a receive-transmit time difference, an AoD, or the like. In some aspects, the set of training measurement information may include location information, such as location information (e.g., information indicating a position or an intermediate value) associated with the measurement information included in the training measurement information. The location information may be associated with the measurement information in that the measurement information relates to measurements performed at a location indicated by the location information. In some other aspects, the set of training measurement information may omit the location information. In some aspects, the UE may perform one or more measurements to obtain the set of training measurement information, such as one or more downlink measurements (e.g., one or more NR measurements).

As shown by reference number 620, the UE may obtain a training position value. For example, the UE may receive the training position value from the node. As another example, the UE may determine the training position value. Examples of training position values, and a node from which each training position value may be received, are provided below. The training position value may include a position (e.g., information indicating a position, an estimate of a position), one or more intermediate values, or a combination thereof. In some aspects, the training position value may include or be provided with measurement information associated with the training position value (such as for training of the model).

In some aspects, the UE may receive a training position value from another UE (e.g., a second UE). For example, the node may comprise the second UE. In some aspects, the second UE may provide the training position value directly to the UE (e.g., via a sidelink). In some aspects, the second UE may provide the training position value to the UE via a network node. In some aspects, the training position value may include information relating to the UE. In some aspects, the training position value may include or indicate a round trip time (RTT) value between the UE and the second UE. In some aspects, the training position value may include information indicating an angle between the UE and the second UE.

In some aspects, the UE may receive a training position value from a network node (e.g., network node 110). For example, the node may comprise the network node. In some aspects, the network node may determine the training position value. For example, the network node may determine the training position value based at least in part on an uplink reference signal (e.g., a sounding reference signal or the like) transmitted by the UE or a measurement report transmitted by the UE, shown by reference number 630. The measurement report may indicate a downlink measurement value determined by the UE, such as one or more measurement values of measurement information determined by the UE. The network node may determine the training position value (e.g., a position or an intermediate value) using the uplink reference signal or the measurement report.

As another example, the network node may provide an uplink intermediate value to the UE. For example, the uplink intermediate value may include a parameter (e.g., determined by the network node) based at least in part on an uplink transmission of the UE. In some aspects, the uplink intermediate value may include an uplink RSRP, an RSTD, a channel multipath value, an LOS value, an uplink CFR, an uplink CIR, or the like. In some aspects, the uplink intermediate value may include a quasi co-location (QCL) relationship. For example, the uplink intermediate value may indicate a QCL relationship between a downlink positioning reference signal (PRS) (e.g., a channel state information reference signal (CSI-RS) configured for positioning measurement) resource and an uplink sounding reference signal (SRS) resource, such that the UE can derive spatial information for transmission of an uplink SRS from spatial information for a downlink PRS, or vice versa. Thus, the network node may augment information available to the UE with observations regarding the uplink, which are not typically available to the UE, thereby improving accuracy of training (e.g., monitoring) of the model.

In some aspects, the network node may provide a corrected value, such as a corrected value of a set of training measurement information or a corrected measurement value, to the UE. For example, the UE may transmit (e.g., report) a measurement value (e.g., an RSTD, an RSRP, an RSRPP, a receive/transmit time difference, or an AoD, among other examples) to the network node, as described with regard to reference number 630. For example, the measurement value may be included in the measurement report, or may be provided in the set of training measurement information. As another example, the measurement report may include the set of training measurement information. The network node may use the measurement value and/or the set of training measurement information to determine a corrected value, such as the corrected value of the set of training measurement information or the corrected measurement value. For example, the network node may determine the corrected value based at least in part on determining an estimate of a location of the UE. The network node may determine the estimate of the location using the set of training measurement information or the reported measurement value. The network node may provide the corrected value and/or the estimate of the location to the UE. Providing the corrected value and/or the estimate of the location to the UE may be beneficial in situations where the UE does not have access to information indicating a location of a transmission/reception point or beam information of the network node.

In some aspects, the corrected value may relate to one or more measurement values reported by the UE. For example, the measurement value may indicate measurements of a set of cells, and the corrected value may relate to the measurements of the set of cells (e.g., and not measurements performed by the UE on cells other than the set of cells). In some aspects, the corrected value may relate to one or more cells other than the set of cells for which the UE reported measurements. For example, the network node may provide a corrected value (e.g., a ground truth label) for one or more cells for which the UE performed, and did not report, a measurement. In some aspects, the corrected value may relate to one or more cells of the set of cells for which the UE reported measurements, and to one or more cells other than the set of cells for which the UE reported measurements. For example, the network node may provide a corrected value for one or more cells for which the UE has reported measurements and for one or more cells for which the UE has not reported measurements.

In some aspects, the network node may output an indication for the UE to measure one or more cells. The UE may perform a measurement on a reference signal associated with (e.g., transmitted by) the one or more cells in accordance with the indication. For example, the one or more cells may include one or more cells for which the UE is not configured to report measurements, and/or one or more cells for which the UE is not configured to perform measurements. Thus, the network node may indicate for the UE to measure additional cells, which may improve accuracy of determination of a position of the UE using the model.

In some aspects, the UE may obtain the training position value by determining the training position value. For example, the UE may obtain the training position value using a technique other than a radio frequency (e.g., reference signal) measurement (referred to as a non-NR technique). The non-NR technique may include, for example, a Lidar measurement, a GNSS measurement, a non-terrestrial network (NTN) determination, an inertial measurement unit (IMU) sensor measurement, a WiFi location technique, an ultra-wideband (UWB) location technique, a radio frequency identifier (RFID) technique, a passive IoT technique, or the like.

In some aspects, the UE may receive multiple training position values. For example, the UE may receive ground truth labels from multiple sources described above (e.g., from another UE, from a network node, or the like). As another example, the UE may receive a corrected value as a training position value as well as another form of training position value (e.g., an uplink intermediate value, a training position value from a second UE, or the like). Thus, variation in accuracy of ground truth labels from different sources is mitigated and accuracy of training (e.g., monitoring) of the model is improved.

In some aspects, the training position value is per TRP. A TRP may be configured with multiple PRS resource sets (e.g., two PRS resource sets, in some example). A PRS is a type of reference signal used to determine a position of a UE, and may include a CSI-RS configured as a PRS. Each PRS resource set may include one or more PRS resources. A PRS resource may indicate or include one or more resources on which the UE may perform a measurement (e.g., a PRS measurement). The UE may report one or more measurements (e.g., multiple measurements, of one or more types such as an RSTD type, an RSRP type, an RSRPP type, a receive-transmit time difference type, or an AoD type) per TRP. For example, the network node may output a first set of training position values based at least in part on (e.g., indicated as associated with) measurements on PRSs transmitted by a first TRP, a second set of training position values based at least in part on (e.g., indicated as associated with) measurements on PRSs transmitted by a second TRP, and so on. In some aspects, the training position value is per PRS resource set. For example, the network node may output a first set of training position values based at least in part on (e.g., indicated as associated with) measurements on PRSs of a first PRS resource set, a second set of training position values based at least in part on (e.g., indicated as associated with) measurements on PRSs of a second PRS resource set, and so on. For example, if the network node reports a corrected value of an RSTD (e.g., an RSTD error) with regard to one PRS resource of a PRS resource set, the network node may indicate that the corrected value applies to all PRS resources within the PRS resource set (since LOS delay may ideally be the same for all resources). In some aspects, the training position value is per PRS resource. For example, the network node may output a first set of training position values based at least in part on (e.g., indicated as associated with) measurements on PRSs of a first PRS resource, a second set of training position values based at least in part on (e.g., indicated as associated with) measurements on PRSs of a second PRS resource, and so on. For example, for angle measurements or joint timing-angle measurements, the network node may determine and output training position values at the PRS resource level.

In some aspects, the node may output an explicit value of the training position value. For example, the node may output an explicit measurement value, corrected value, position, or the like. In some aspects, the node may output a probability function describing the training position value. For example, the node may output a cumulative density function (CDF) indicating a cumulative density of the training position value (e.g., the corrected value) determined by the network node. In some aspects, the node may output a range or a range delimiter of the training position value, such as a minimum (e.g., the training position value cannot be smaller than X), a maximum (e.g., the training position value cannot be larger than Y), or a combination thereof. In some aspects, the node may output an uncertainty value associated with the training position value, such as a value indicating a standard deviation or a variance of the training position value. In some aspects, the node may output a combination of two or more of the above values.

In some aspects, the UE may receive, and the node may output, the training position value within a time window after transmitting a measurement report (e.g., as shown by reference number 630). For example, the UE may receive the training position value (e.g., a corrected value of the training position value) within a time window (e.g., a T ms time window) after transmitting the measurement report. In some aspects, the UE may receive, and the node may output, the training position value in a batch of training position values. For example, the UE may report multiple measurements (e.g., a batch of measurements) in a single measurement report (e.g., in a single message). Each measurement reported in the measurement report may include a time stamp indicating a time at which each measurement was performed. In some aspects, the node may output a batch of training position values regarding multiple measurements of a measurement report. For example, the node may output the batch of training position values in accordance with a maximum time window (e.g., a time window, after receiving the measurement report, within which the batch of training position values should be outputted), a maximum batch size (e.g., a maximum number of training position values that can be included in the batch of training position values), or a combination thereof. In some aspects, the maximum time window and/or the maximum batch size may be specified, for example, in a wireless communication specification. In some aspects, the node may drop one or more training position values (e.g., one or more individual training position values, one or more batches of training position values, or a combination thereof), for example, based at least in part on a processing capability of the node, on preemption by a higher-priority transmission, or the like.

As shown by reference number 640, the UE may provide the training position value(s) and/or the set of training measurement information for training of the model. For example, the UE may provide the training position value(s) and/or the set of training measurement information to a server (e.g., an AI/ML server) for training (e.g., monitoring) of the model using an ML algorithm. As another example, the UE may provide the training position value(s) and/or the set of training measurement information to an ML algorithm of the UE for training of the model using the ML algorithm. As mentioned above, “training” may include monitoring the model. For example, the UE or the server may compare an output of the model to a training position value (e.g., a ground truth label). If the output of the model deviates from the training position value by a threshold amount, the UE or the server may train the model using the training position value. In this way, accuracy of training and operation of the model is improved. In some aspects, the UE or the server may use the model. For example, the UE or the server may determine location information using the model and measurement information determined by the UE.

As indicated above, FIG. 6 is provided as an example. Other examples may differ from what is described with regard to FIG. 6.

FIG. 7 is a diagram illustrating an example process 700 performed, for example, by an apparatus, in accordance with the present disclosure. Example process 700 is an example where the apparatus (e.g., an apparatus of UE 120, a server such as an AI/ML server, or the like) performs operations associated with positioning model performance monitoring.

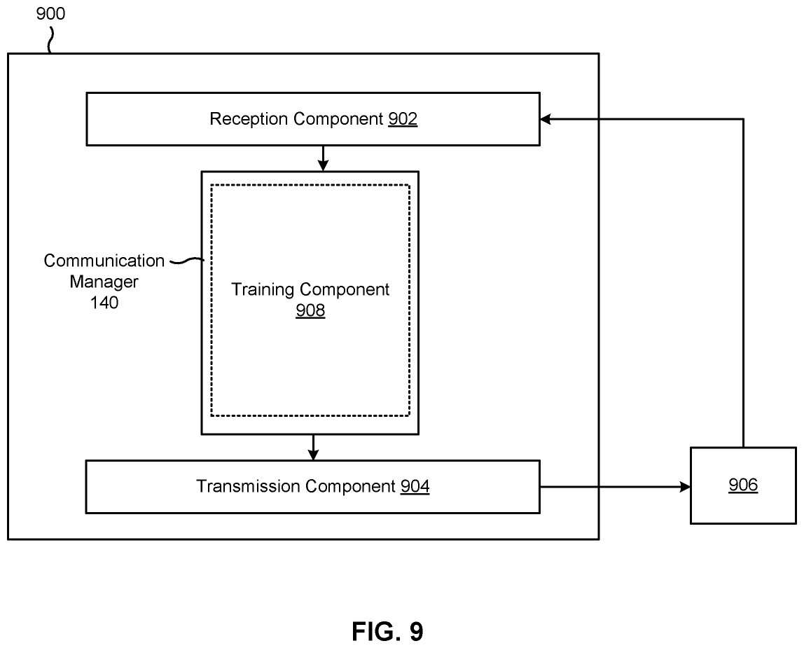

As shown in FIG. 7, in some aspects, process 700 may include obtaining a set of training measurement information associated with a UE (block 710). For example, the apparatus (e.g., using communication manager 140 and/or transmission component 904 or training component 908, depicted in FIG. 9) may obtain a set of training measurement information associated with a UE (e.g., a UE including the apparatus or another UE), as described above.

As further shown in FIG. 7, in some aspects, process 700 may include obtaining a training position value associated with the UE (block 720). For example, the apparatus (e.g., using communication manager 140 and/or reception component 902, depicted in FIG. 9) may obtain a training position value associated with the UE, as described above. In some aspects, the apparatus may obtain the training position value by determining the training position value. In some other aspects, the apparatus may receive the training position value from a node.

As further shown in FIG. 7, in some aspects, process 700 may include providing the training position value and the set of training measurement information for training of a model using an ML technique, the model being trained to output location information based at least in part on measurement information (block 730). For example, the apparatus (e.g., using communication manager 140 and/or transmission component 904 or training component 908, depicted in FIG. 9) may provide the training position value and the set of training measurement information for training or performance monitoring of a model using an ML technique, the model being trained to output location information based at least in part on measurement information, as described above.

Process 700 may include additional aspects, such as any single aspect or any combination of aspects described below and/or in connection with one or more other processes described elsewhere herein.

In a first aspect, the node comprises a second UE.

In a second aspect, alone or in combination with the first aspect, receiving the training position value from the node comprises receiving the training position value from the node via a network node or another UE.

In a third aspect, alone or in combination with one or more of the first and second aspects, the training position value is based at least in part on at least one of an uplink reference signal or a measurement report of the UE.

In a fourth aspect, alone or in combination with one or more of the first through third aspects, the training position value comprises an estimate of a location of the UE or an estimate of an intermediate value derived from the uplink reference signal or the measurement report.

In a fifth aspect, alone or in combination with one or more of the first through fourth aspects, the training position value comprises an intermediate value comprising at least one of a reference signal received power value, a reference signal time difference value, a channel multipath value, line of sight information, an uplink channel frequency response value, an uplink channel impulse response value, quasi co-location information, or a combination thereof.

In a sixth aspect, alone or in combination with one or more of the first through fifth aspects, process 700 includes transmitting information indicating a measurement value to the node, the training position value being based at least in part on the measurement value.

In a seventh aspect, alone or in combination with one or more of the first through sixth aspects, the training position value indicates at least one of a corrected value of the set of training measurement information based at least in part on the measurement value, or a corrected measurement value based at least in part on the measurement value.

In an eighth aspect, alone or in combination with one or more of the first through seventh aspects, the corrected measurement value is based at least in part on an uplink measurement at the node.

In a ninth aspect, alone or in combination with one or more of the first through eighth aspects, the corrected measurement value is based at least in part on the training measurement information.

In a tenth aspect, alone or in combination with one or more of the first through ninth aspects, the measurement value indicates measurements of a set of cells, and the training position value relates to the set of cells.

In an eleventh aspect, alone or in combination with one or more of the first through tenth aspects, the training position value further relates to one or more cells, measured by the UE, other than the set of cells.

In a twelfth aspect, alone or in combination with one or more of the first through eleventh aspects, process 700 includes performing a measurement on a reference signal associated with the one or more cells.

In a thirteenth aspect, alone or in combination with one or more of the first through twelfth aspects, the training position value is one of per transmission reception point, per PRS resource set, or per PRS resource.

In a fourteenth aspect, alone or in combination with one or more of the first through thirteenth aspects, the training position value comprises at least one of an explicit value of the training position value, a probability function, a range or a range delimiter of the training position value, an uncertainty value associated with the training position value, or a combination thereof.

In a fifteenth aspect, alone or in combination with one or more of the first through fourteenth aspects, receiving the training position value further comprises receiving the training position value within a time window after transmitting a measurement report.

In a sixteenth aspect, alone or in combination with one or more of the first through fifteenth aspects, receiving the training position value further comprises receiving the training position value in a batch of training position values.

In a seventeenth aspect, alone or in combination with one or more of the first through sixteenth aspects, the UE comprises the apparatus.

In an eighteenth aspect, alone or in combination with one or more of the first through seventeenth aspects, providing the training measurement information and the training position value for training of the model further comprises training the model using the training measurement information and the training position value.

In a nineteenth aspect, alone or in combination with one or more of the first through eighteenth aspects, providing the training measurement information and the training position value for training of the model further comprises providing the training measurement information and the training position value to a server associated with the model.

In a twentieth aspect, alone or in combination with one or more of the first through nineteenth aspects, process 700 includes determining the location information using the model and the measurement information.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110, the node of FIG. 6) performs operations associated with positioning model performance monitoring.

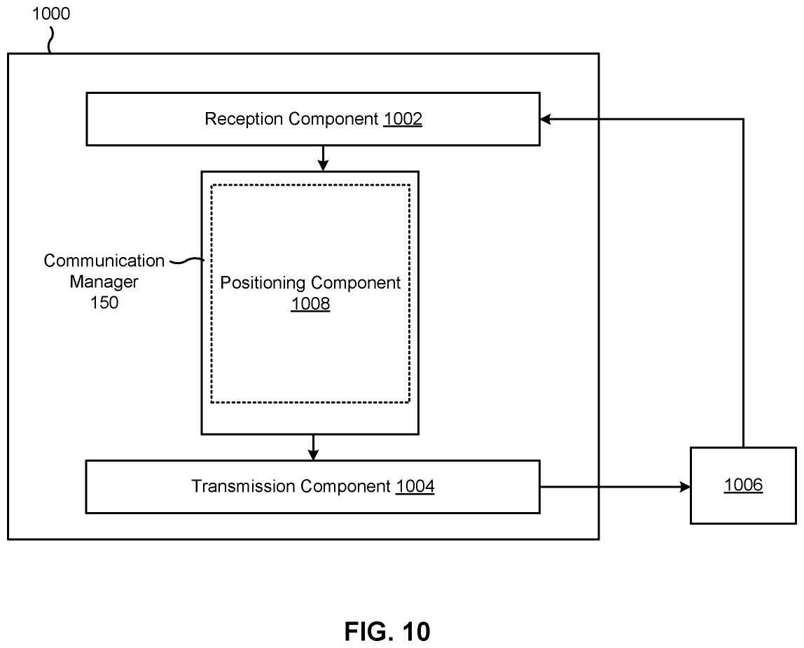

As shown in FIG. 8, in some aspects, process 800 may include obtaining training measurement information for a UE, or information associated with the training measurement information, the training measurement information being associated with training a model using an ML technique (block 810). For example, the network node (e.g., using communication manager 150 and/or reception component 1002, depicted in FIG. 10) may obtain training measurement information for a UE, or information associated with the training measurement information, the training measurement information being associated with training a model using an ML technique, as described above. The information associated with the training measurement information may include, for example, an uplink reference signal transmission, an uplink measurement, a measurement value reported by the UE, or another value described as being received by the node of FIG. 6.

As further shown in FIG. 8, in some aspects, process 800 may include outputting, for the UE, a training position value based at least in part on the training measurement information or the information associated with the training measurement information (block 820). For example, the network node (e.g., using communication manager 150 and/or transmission component 1004, depicted in FIG. 10) may output, for the UE, a training position value based at least in part on the training measurement information or the information associated with the training measurement information, as described above.

Process 800 may include additional aspects, such as any single aspect or any combination of aspects described below and/or in connection with one or more other processes described elsewhere herein.

In a first aspect, the training position value is based at least in part on at least one of an uplink reference signal or a measurement report of the UE.

In a second aspect, alone or in combination with the first aspect, the training position value comprises an estimate of a location of the UE or an estimate of an intermediate value derived from the uplink reference signal or the measurement report.

In a third aspect, alone or in combination with one or more of the first and second aspects, the training position value comprises an intermediate value comprising at least one of a reference signal received power value, a reference signal time difference value, a channel multipath value, line of sight information, an uplink channel frequency response value, an uplink channel impulse response value, quasi co-location information, or a combination thereof.

In a fourth aspect, alone or in combination with one or more of the first through third aspects, the information associated with the training measurement information comprises information indicating a downlink measurement value, wherein outputting the training position value further comprises outputting the training position value based at least in part on the downlink measurement value.

In a fifth aspect, alone or in combination with one or more of the first through fourth aspects, the training position value indicates at least one of a corrected value of the training measurement information based at least in part on the downlink measurement value, or a corrected measurement value based at least in part on the downlink measurement value.

In a sixth aspect, alone or in combination with one or more of the first through fifth aspects, process 800 includes performing an uplink measurement, wherein the corrected measurement value is based at least in part on the uplink measurement.

In a seventh aspect, alone or in combination with one or more of the first through sixth aspects, the corrected measurement value is based at least in part on the downlink measurement value.

In an eighth aspect, alone or in combination with one or more of the first through seventh aspects, the downlink measurement value relates to a set of cells, and the training position value relates to the set of cells.

In a ninth aspect, alone or in combination with one or more of the first through eighth aspects, the training position value further relates to one or more cells, measured by the UE, other than the set of cells.

In a tenth aspect, alone or in combination with one or more of the first through ninth aspects, process 800 includes outputting an indication for the UE to measure the one or more cells.

In an eleventh aspect, alone or in combination with one or more of the first through tenth aspects, the training position value is one of per transmission reception point, per PRS resource set, or per PRS resource.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. In some aspects, the apparatus 900 may be a UE. In some aspects, a UE may include the apparatus 900. In some aspects, the apparatus 900 may be a server, such as an AI/ML server. In some aspects, a server may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a training component 908, among other examples.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

In some aspects, the transmission component 904 may obtain a set of training measurement information associated with a UE. In some aspects, the training component 908 may obtain the set of training measurement information. The reception component 902 or the training component 908 may obtain a training position value associated with the UE. The transmission component 904 may provide the training position value and the set of training measurement information for training of a model using an ML technique, the model being trained to output location information based at least in part on measurement information. In some aspects, the training component 908 may obtain the training position value and the set of training measurement information for training of a model using an ML technique, the model being trained to output location information based at least in part on measurement information.

The transmission component 904 may transmit information indicating a measurement value to the node, the training position value being based at least in part on the measurement value.

The reception component 902 may perform a measurement on a reference signal (e.g., a PRS) associated with the one or more cells.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a positioning component 1008, among other examples.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The reception component 1002 may obtain (e.g., receive from a UE, receive from another network node) training measurement information for a UE, or information associated with the training measurement information, the training measurement information being associated with training a model using an ML technique. The transmission component 1004 or the positioning component 1008 may output (e.g., transmit to the UE or provide to another network node for transmission), for the UE, a training position value based at least in part on the training measurement information or the information associated with the training measurement information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by an apparatus, comprising: obtaining a set of training measurement information associated with a user equipment (UE); obtaining a training position value associated with the UE; and providing the training position value and the set of training measurement information for training or performance monitoring of a model using a machine learning (ML) technique, the model being trained to output location information based at least in part on measurement information.
Aspect 2: The method of Aspect 1, wherein the training position value is based at least in part on at least one of an uplink reference signal or a measurement report of the UE.
Aspect 3: The method of Aspect 2, wherein the training position value comprises an estimate of a location of the UE or an estimate of an intermediate value derived from the uplink reference signal or the measurement report.
Aspect 4: The method of any of Aspects 1-3, wherein the training position value comprises an intermediate value comprising at least one of: a reference signal received power value, a reference signal time difference value, a channel multipath value, line of sight information, an uplink channel frequency response value, an uplink channel impulse response value, quasi co-location information, or a combination thereof.
Aspect 5:The method of any of Aspects 1-4, wherein obtaining the training position value further comprises receiving the training position value from a node.
Aspect 6: The method of Aspect 5, wherein the node comprises a second UE.
Aspect 7: The method of Aspect 5, wherein receiving the training position value from the node comprises receiving the training position value from the node via a network node or another UE.
Aspect 8: The method of Aspect 5, further comprising transmitting information indicating a measurement value to the node, the training position value being based at least in part on the measurement value.
Aspect 9: The method of Aspect 8, wherein the training position value indicates at least one of: a corrected value of the set of training measurement information based at least in part on the measurement value, or a corrected measurement value based at least in part on the measurement value.
Aspect 10: The method of Aspect 9, wherein the corrected measurement value is based at least in part on an uplink measurement at the node.
Aspect 11: The method of Aspect 9, wherein the corrected measurement value is based at least in part on the set of training measurement information.
Aspect 12: The method of Aspect 8, wherein the measurement value indicates measurements of a set of cells, and wherein the training position value relates to the set of cells.
Aspect 13: The method of Aspect 12, wherein the training position value further relates to one or more cells, measured by the UE, other than the set of cells.
Aspect 14: The method of Aspect 13, further comprising receiving an indication to measure the one or more cells, the method further comprising performing a measurement on a reference signal associated with the one or more cells.
Aspect 15: The method of Aspect 8, wherein the training position value is one of: per transmission reception point, per positioning reference signal (PRS) resource set, or per PRS resource.
Aspect 16: The method of any of Aspects 1-15, wherein the training position value comprises at least one of: an explicit value of the training position value, a probability function, a range or a range delimiter of the training position value, an uncertainty value associated with the training position value, or a combination thereof.
Aspect 17: The method of any of Aspects 1-16, wherein obtaining the training position value further comprises receiving the training position value within a time window after transmitting a measurement report.
Aspect 18: The method of any of Aspects 1-17, wherein obtaining the training position value further comprises receiving the training position value in a batch of training position values.
Aspect 19: The method of any of Aspects 1-18, wherein the UE comprises the apparatus.
Aspect 20: The method of any of Aspects 1-19, wherein providing the set of training measurement information and the training position value for training of the model further comprises training the model using the set of training measurement information and the training position value.
Aspect 21: The method of any of Aspects 1-20, wherein providing the set of training measurement information and the training position value for training of the model further comprises providing the set of training measurement information and the training position value to a server associated with the model.
Aspect 22: The method of any of Aspects 1-21, further comprising determining the location information using the model and the measurement information.
Aspect 23: A method of wireless communication performed by a network node, comprising: obtaining training measurement information for a user equipment (UE), or information associated with the training measurement information, the training measurement information being associated with training or performance monitoring of a model using a machine learning (ML) technique; and outputting, for the UE, a training position value based at least in part on the training measurement information or the information associated with the training measurement information.
Aspect 24: The method of Aspect 23, wherein the training position value is based at least in part on at least one of an uplink reference signal or a measurement report of the UE.
Aspect 25: The method of Aspect 24, wherein the training position value comprises an estimate of a location of the UE or an estimate of an intermediate value derived from the uplink reference signal or the measurement report.
Aspect 26: The method of any of Aspects 23-25, wherein the training position value comprises an intermediate value comprising at least one of: a reference signal received power value, a reference signal time difference value, a channel multipath value, line of sight information, an uplink channel frequency response value, an uplink channel impulse response value, quasi co-location information, or a combination thereof.
Aspect 27: The method of any of Aspects 23-26, wherein the information associated with the training measurement information comprises information indicating a downlink measurement value, wherein outputting the training position value further comprises outputting the training position value based at least in part on the downlink measurement value.
Aspect 28: The method of Aspect 27, wherein the training position value indicates at least one of: a corrected value of the training measurement information based at least in part on the downlink measurement value, or a corrected measurement value based at least in part on the downlink measurement value.
Aspect 29: The method of Aspect 28, further comprising performing an uplink measurement, wherein the corrected measurement value is based at least in part on the uplink measurement.
Aspect 30: The method of Aspect 28, wherein the corrected measurement value is based at least in part on the downlink measurement value.
Aspect 31: The method of Aspect 27, wherein the downlink measurement value relates to a set of cells, and wherein the training position value relates to the set of cells.
Aspect 32: The method of Aspect 31, wherein the training position value further relates to one or more cells, measured by the UE, other than the set of cells.
Aspect 33: The method of Aspect 32, further comprising outputting an indication for the UE to measure the one or more cells.
Aspect 34: The method of Aspect 27, wherein the training position value is one of: per transmission reception point, per positioning reference signal (PRS) resource set, or per PRS resource.
Aspect 35: An apparatus for wireless communication at a device, comprising a processor; memory coupled with the processor; and instructions stored in the memory and executable by the processor to cause the apparatus to perform the method of one or more of Aspects 1-34.
Aspect 36: A device for wireless communication, comprising a memory and one or more processors coupled to the memory, the one or more processors configured to perform the method of one or more of Aspects 1-34.
Aspect 37: An apparatus for wireless communication, comprising at least one means for performing the method of one or more of Aspects 1-34.
Aspect 38: A non-transitory computer-readable medium storing code for wireless communication, the code comprising instructions executable by a processor to perform the method of one or more of Aspects 1-34.
Aspect 39: A non-transitory computer-readable medium storing a set of instructions for wireless communication, the set of instructions comprising one or more instructions that, when executed by one or more processors of a device, cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication, comprising:
a memory; and
one or more processors, coupled to the memory, configured to:
obtain a set of training measurement information associated with a user equipment (UE);
obtain a training position value associated with the UE; and
provide the training position value and the set of training measurement information for training or performance monitoring of a model using a machine learning (ML) technique, the model being trained to output location information based at least in part on measurement information.

2. The apparatus of claim 1, wherein the training position value is based at least in part on at least one of an uplink reference signal or a measurement report of the UE.

3. The apparatus of claim 2, wherein the training position value comprises an estimate of a location of the UE or an estimate of an intermediate value derived from the uplink reference signal or the measurement report.

4. The apparatus of claim 1, wherein the training position value comprises an intermediate value comprising at least one of:
a reference signal received power value,
a reference signal time difference value,
a channel multipath value,
line of sight information,
an uplink channel frequency response value,
an uplink channel impulse response value,
quasi co-location information, or
a combination thereof.

5. The apparatus of claim 1, wherein the one or more processors, to obtain the training position value, are configured to receive the training position value from a node.

6. The apparatus of claim 5, wherein the node comprises a second UE.

7. The apparatus of claim 5, wherein the one or more processors, to receive the training position value from the node, are configured to receive the training position value from the node via a network node or another UE.

8. The apparatus of claim 5, wherein the one or more processors are further configured to transmit information indicating a measurement value to the node, the training position value being based at least in part on the measurement value.

9. The apparatus of claim 8, wherein the training position value indicates at least one of:
a corrected value of the set of training measurement information based at least in part on the measurement value, or
a corrected measurement value based at least in part on the measurement value.

10. The apparatus of claim 8, wherein the measurement value indicates measurements of a set of cells, and wherein the training position value relates to the set of cells.

11. The apparatus of claim 8, wherein the training position value comprises at least one of:
an explicit value of the training position value,
a probability function,
a range or a range delimiter of the training position value,
an uncertainty value associated with the training position value, or
a combination thereof.

12. The apparatus of claim 8, wherein the one or more processors, to receive the training position value, are configured to receive the training position value within a time window after transmitting a measurement report.

13. The apparatus of claim 1, wherein the one or more processors, to receive the training position value, are configured to receive the training position value in a batch of training position values.

14. The apparatus of claim 1, wherein the UE comprises the apparatus.

15. The apparatus of claim 1, wherein the one or more processors, to provide the set of training measurement information and the training position value for training or performance monitoring of the model, are configured to train the model using the set of training measurement information and the training position value.

16. The apparatus of claim 1, wherein the one or more processors, to provide the set of training measurement information and the training position value for training or performance monitoring of the model, are configured to provide the set of training measurement information and the training position value to a server associated with the model.

17. A network node for wireless communication, comprising:
a memory; and
one or more processors, coupled to the memory, configured to:
obtain training measurement information for a user equipment (UE), or information associated with the training measurement information, the training measurement information being associated with training or performance monitoring of a model using a machine learning (ML) technique; and
output, for the UE, a training position value based at least in part on the training measurement information or the information associated with the training measurement information.

18. The network node of claim 17, wherein the training position value is based at least in part on at least one of an uplink reference signal or a measurement report of the UE.

19. The network node of claim 17, wherein the training position value comprises an intermediate value comprising at least one of:
a reference signal received power value,
a reference signal time difference value,
a channel multipath value,
line of sight information,
an uplink channel frequency response value,
an uplink channel impulse response value,
quasi co-location information, or
a combination thereof.

20. The network node of claim 17, wherein the information associated with the training measurement information comprises information indicating a downlink measurement value, wherein the one or more processors, to output the training position value, are configured to output the training position value based at least in part on the downlink measurement value.

21. The network node of claim 20, wherein the downlink measurement value relates to a set of cells, and wherein the training position value relates to the set of cells.

22. The network node of claim 20, wherein the training position value is one of:
per transmission reception point,
per positioning reference signal (PRS) resource set, or
per PRS resource.

23. A method of wireless communication performed by an apparatus, comprising:
obtaining a set of training measurement information associated with a user equipment (UE);
obtaining a training position value associated with the UE; and
providing the training position value and the set of training measurement information for training or performance monitoring of a model using a machine learning (ML) technique, the model being trained to output location information based at least in part on measurement information.

24. The method of claim 23, wherein obtaining the training position value comprises receiving the training position value from a node via a network node or another UE.

25. The method of claim 23, wherein the training position value is based at least in part on at least one of an uplink reference signal or a measurement report of the UE.

26. A method of wireless communication performed by a network node, comprising:
obtaining training measurement information for a user equipment (UE), or information associated with the training measurement information, the training measurement information being associated with training or performance monitoring of a model using a machine learning (ML) technique; and
outputting, for the UE, a training position value based at least in part on the training measurement information or the information associated with the training measurement information.

27. The method of claim 26, wherein the training position value is based at least in part on at least one of an uplink reference signal or a measurement report of the UE.

28. The method of claim 27, wherein the training position value comprises an estimate of a location of the UE or an estimate of an intermediate value derived from the uplink reference signal or the measurement report.

29. The method of claim 26, wherein the training position value comprises an intermediate value comprising at least one of:
a reference signal received power value,
a reference signal time difference value,
a channel multipath value,
line of sight information,
an uplink channel frequency response value,
an uplink channel impulse response value,
quasi co-location information, or
a combination thereof.

30. The method of claim 26, wherein the training position value is one of:
per transmission reception point,
per positioning reference signal (PRS) resource set, or
per PRS resource.
